(19) United States
(12) Patent Application Publication
(10) Pub. No.: US 2017/0157527 A1
(43) Pub. Date: Jun. 8, 2017

(54) Humidification System with Pressure Condensate Return and Method Therefor

(71) Applicant: National Environmental Products, Ltd., St. Laurent (CA)

(72) Inventors: Zev W. Kopel, Montreal (CA); Eric Landry, Montreal (CA)

(73) Assignee: National Environmental Products, Ltd., St. Laurent (CA)

(21) Appl. No.: 14/972,383

(22) Filed: Dec. 17, 2015

Related U.S. Application Data
(60) Provisional application No. 62/264,066, filed on Dec. 7, 2015.

(51) Int. Cl. B01D 5/00; F04F 1/06; F28B 11/00; F24F 6/18; F28B 9/08

(52) U.S. Cl. CPC B01D 5/0039; F24F 6/18; F28B 9/08; F28B 11/00; B01D 5/0051; F04F 1/06

(57) ABSTRACT

Supplied humidification steam is dispersed through tubes and a header. Condensate is collected from the header into a tank. A controlled steam supply valve pumps condensate from the tank to a return line by application of sourced steam. A non-mechanical electronic level sensor (ELS, sensing temperature, resistance, capacitance, inductance, luminance or sonic condition of condensate) signals a controller using the ELS and/or a timed pumping/evacuation cycle to push condensate from the tank to the return. The method removes condensate by isolating the collection tank from the tubes and header and pumps condensate from the tank based upon a sensed conditions.

This a patent application is based upon and claims the priority of provisional patent application Ser. No. 62/264,066, filed Dec. 7, 2015, the contents of which is incorporated herein by reference thereto.

The present invention relates to a steam humidification system which removes condensate from steam distribution tubes coupled to a header via a pressure powered condensate return system. In some systems, the pressure powered condensate removal system includes a pressure motive pump operative on the condensate.

The problem solved by the present invention is the removal of condensate from the lower regions of steam header which header feeds humidification steam to distribution pipes or tubes in heat, ventilation and air conditioning or HVAC ductwork.

Condensate is created in steam distribution tubes when steam at a higher temperature, as compared to the air in the duct, exits the tubes and is dispersed in the HVAC ductwork. Some steam humidification systems are mounted in HVAC or heat-ventilation ductwork. At other times, the steam dispersion apparatus is mounted in a chamber or walled off region leading to HVAC ductwork. Normally with respect to vertically mounted steam distribution tubes, condensate forms in the steam distribution tubes and falls down via gravity from the distribution tubes and into the lower regions of a steam header (the header feeds humidification steam to the distribution tubes). The invention effectively removes condensate from the steam header via a pressure condensate return system.

With respect to horizontally mounted steam dispersion tubes, the tubes may be positioned to drain condensate to a vertically oriented steam distribution header such that condensate moves from the tubes to the vertically lower region(s) in the header. Horizontally mounted steam dispersion tubes usually are set at a slight down-angle, such as about 3-4 degrees, angled downward to drain condensate to the header.

### BACKGROUND

Prior art condensate return pumps from Watson McDaniel of Pottstown, Pa. (see www.watsonmcdaniel.com) disclose basic pressure motive pump technology. U.S. Pat. No. 5,938,409 to Radle entitled “Gas Powered Fluid Pump with Exhaust Assist Valve” and U.S. Pat. No. 7,520,731 to Langdon entitled “Gas Pressure Driven Pump Having Dual Pump Mechanisms” and U.S. Pat. No. 8,858,190 to Collins entitled “Steam Powered Pump” also disclose pressure motive pumps.

The Radle '409 patent describes a pressure motive pump which moves condensate from a container. Condensate is delivered to the container via an inlet and, when a water level sensing float mechanism reaches a certain level in the container, a valving system changes its positional state and injects pressurized gas into the container, thereby permitting pressurized steam to enter into containment area. At the same time, the valve at a containment inlet is closed and another valve at a fluid containment outlet is opened. The pressurized steam then forces the condensate out of fluid outlet.

The Langdon '731 patent discloses a pressure motive pump with a float valve that senses the level of condensate in the container. The float valve has a mechanical linkage, water level sensing mechanism.

The Collins '340 patent also shows a float valve and a mechanical linkage mechanism. The Collins '190 patent discloses the use of a pressure motive pump in a heat exchanger system. The Collins system is also used to move condensate in humidification systems.

### OBJECTS OF THE INVENTION

It is an object of the present invention to provide a pressure condensate return system for a steam distribution apparatus.

It is another object of the present invention to remove and propel condensate from a collection container or tank via the controlled application of supply steam into the collection canister, container or tank (the container being a collection vessel for the condensate from the steam distribution apparatus).

It is a further object of the present invention to utilize a non-mechanical, electronic level sensor sensing the a condensate level in the collection canister, container or tank. The non-mechanical, electronic level sensor (“ELS”) senses a gas-liquid differential in temperature, resistance, capacitance, inductance, luminance or sonic condition of condensate in the collection tank. A variety of a non-mechanical electronic level sensors can sense condensate level in the collection tank by differentiation with the gas volume therein. The ELS can be mounted inside or outside the collection vessel.

An additional object of the present invention is to provide a condensate collection tank substantially without any mechanical obstructive elements within the tank, including mechanical moving parts to substantially facilitate, reduce or eliminate the impedance of mineral and other deposits on the functioning of the condensate evacuation system.

Another object of the present invention is to remove and propel condensate from the collection cannister or tank without moving parts (or mechanical elements) in the tank because such moving parts tend to clog with the buildup of deposits form the condensate.

It is an additional object of the present invention to periodically remove collected condensate from the collection container via the controlled application of pressure pulse to a substantially closed container.

### BRIEF DESCRIPTION OF THE DRAWINGS

Further objects and advantages of the present invention are discussed in the detailed description of various embodiments of the present invention when taken in conjunction with the accompanying drawings.

FIG. 1 diagrammatically illustrates a pressure condensate return system for a steam distribution apparatus in a steam distribution system.

FIG. 2 diagrammatically illustrates one embodiment of the collection container or tank for the pressure condensate return system.

FIGS. 3A and 3B diagrammatically illustrate different embodiments of the pressure condensate return system and, more particularly, the condensate collection container (one utilizing a pair of ELS or electronic level sensors in or on the tank (FIG. 3A) and the other utilizing a combinatory valve (normally closed (NC)) at the steam supply side; normally open (NO) at the pressure relief side (FIG. 3B). During the condensate pump phase, the condition of the valve changes to OPEN at the steam supply route and CLOSED at the relief route.

FIG. 4A diagrammatically illustrates a timing chart for the pressure condensate return system wherein the activation of the pressure pulse to pump out condensate from the container is a function of “time after activation” of humidification steam control valve SCV, that is, a function of time-differential plus humidification start time SCV (see f(SCV), “f” referring to a function of the SCV ON variable).

FIG. 4B diagrammatically illustrates a timing chart for the pressure condensate return system wherein the activation of the pressure pulse to pump out condensate from the container being a function of ELS sensor, that is, the LEVEL L condition of the ELS (see f(L)).

FIG. 5 diagrammatically illustrates a different timing chart for the pressure condensate return system wherein combinatory control signals are applied to the pressure steam supply valve SSV (supplying pressure to the pressure condensate return PCR tank), namely, (a) activation of one or more pressure pulses to pump out condensate from the container being a function of the “length of time of distributed humidification steam” supplied to the steam distribution header (a function of the humidification steam control valve SCV, that is, f(SCV)); (b) activation of the pressure pulse to pump out condensate from the container being a function of level signal L from the ELS (see f(L)); and (c) activation of the pressure pulse to pump out condensate from the container being a function of the time of SCV ON, that is f(SCV), and a follow-on condensate PCR container clean-out pressure pulse after the SCV valve is closed or OFF, that is, a further function f(SCV).

FIG. 6 diagrammatically illustrates a pressure condensate return system for horizontal steam distribution tubes in a steam distribution system.

FIG. 7 diagrammatically illustrates multiple locations for the placement of ELS sensors (S3, S4, S5 and S6) for the pressure condensate return system.

### SUMMARY OF THE INVENTION

The steam dispersion apparatus is supplied with steam from a steam source. A number of steam dispersion tubes are coupled to a header in communication with the steam source. A condensate collection tank is in communication with the header and is configured to collect condensate from the header and the steam dispersion tubes. An electronic sensor senses the level of condensate in the collection tank. A controlled steam supply valve pumps condensate from the collection tank based upon the level of condensate detected by the sensor. The electronic level sensor or ELS is a non-mechanical sensor sensing the condensate level or the condition of condensate in the condensate tank. In one embodiment, the ELS senses a gas-liquid differential of temperature, resistance, capacitance, inductance, luminance or sonic condition of condensate in the collection chamber. In other embodiments, the ELS employs a sensor for either temperature, resistance, capacitance, inductance, luminance or sonic condition of the condensate in the collection tank.

The steam dispersion apparatus is part of a steam dispersion system which includes a drain in communication with the header and the collection tank. A controller for the steam supply valve indicates either the presence or the absence of condensate in the collection tank, header or drain based upon the electronic sensor. The system includes a first drain line and at least one condensate return line, and a second drain line in communication with the collection tank and the condensate return line for evacuation of the condensate from the collection tank. The steam supply valve is usually in communication with the steam source which controlled steam which is used to pump condensate from the collection tank.

Sometimes a timer is used to control the controlled steam valve and for pumping condensate from the collection tank.

As for the controller, the ELS is coupled to the controller for controlling the steam supply valve and the ON-OFF application of motive pumping steam to the collection tank. The system includes a controlled pressure relief line in communication with the collection tank to release steam after the steam supply valve turns OFF pumping steam to the collection tank, with the controller being coupled to the controlled pressure relief line. A first valve prohibits flow from the tank to the header.

The method of removing condensate from a steam dispersion apparatus supplied with steam from a steam source includes the process of draining condensate from steam dispersion tubes and an associated header into a condensate collection tank; isolating condensate in the collection tank from the dispersion tubes and header; and pumping condensate from the isolated collection tank based upon a non-mechanically sensed condensate level in the collection tank or the header. The non-mechanical sensing of condensate level is carried out with sensing temperature, resistance, capacitance, inductance, luminance or sonic condition of the condensate.

### PREFERRED EMBODIMENTS OF THE PRESENT INVENTION

The present invention relates to a steam humidification system which removes condensate from steam distribution tubes coupled to a header via a pressure powered condensate return system. In some systems, the pressure powered condensate removal system includes a pressure motive pump operative on the condensate. Similar numerals designate similar items throughout the drawings.

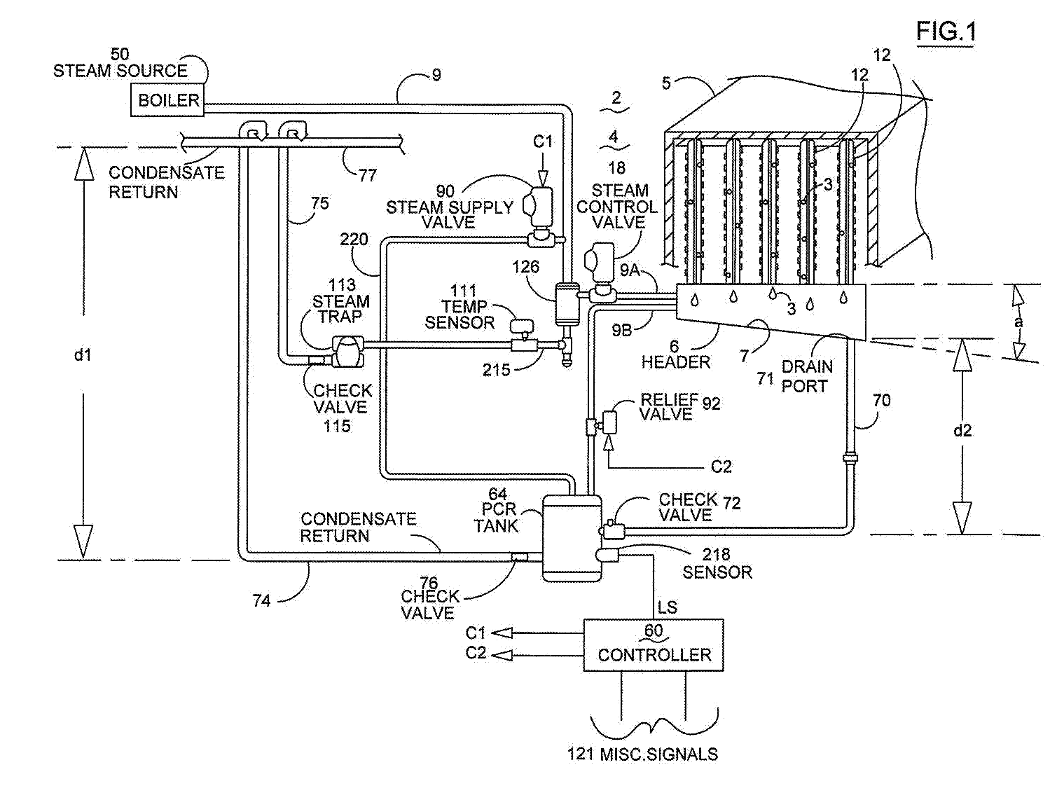

A brief operational description follows. FIG. 1 shows that condensate from the header moves by gravity through piping 70 through the check valve 72 into PCR tank 64. Check valve 72 prevents any condensate in the tank to move back into the piping 70. After predetermined time when there is sufficient condensate accumulation in tank 64, steam supply valve 90 opens and the pressurized steam from the boiler pressurizes tank 64 until the pressure in the tank is greater than the pressure in the condensate return 74. Condensate in 74 is prevented from flowing into PCR 64 by check valve 76. When finally the pressure in tank 64 overcomes the pressure in piping 74, check valve 76 opens and the condensate from the tank is propelled in the piping 74 and sent back to the boiler.

The electronic level sensor 218 or ELS is, in one embodiment, a temperature sensor that senses the steam temperature when all the condensate is evacuated and then controller 60 closes the steam supply valve 90. The PCR tank is still under pressure even after valve 90 is closed preventing condensate from the header to flow into PCR tank since the check valve is closed by the said pressure. At that moment, the relief valve 92 equalizes the pressures between PCR tank and header 6 allowing check valve 72 to open and let the condensate to flow again into the PCR tank. The sequence of operation is electronically controlled by controller 60 based upon the humidification cycle and the ELS signals.

FIG. 1 illustrates a steam distribution system 2 (generally, boiler or other steam supply 50, duct 5 or a steam closet, dispersion tubes 12, valves, piping, etc.). System 2 includes a steam dispersion apparatus 4 (generally, dispersion tubes 12, header 6, valves, piping, etc.). FIG. 1 illustrates steam distribution tubes 12 in a vertical orientation. Distribution tubes 12 extend into the heat-ventilation-AC (HVAC) ductwork (or steam cabinet) and release steam therein.

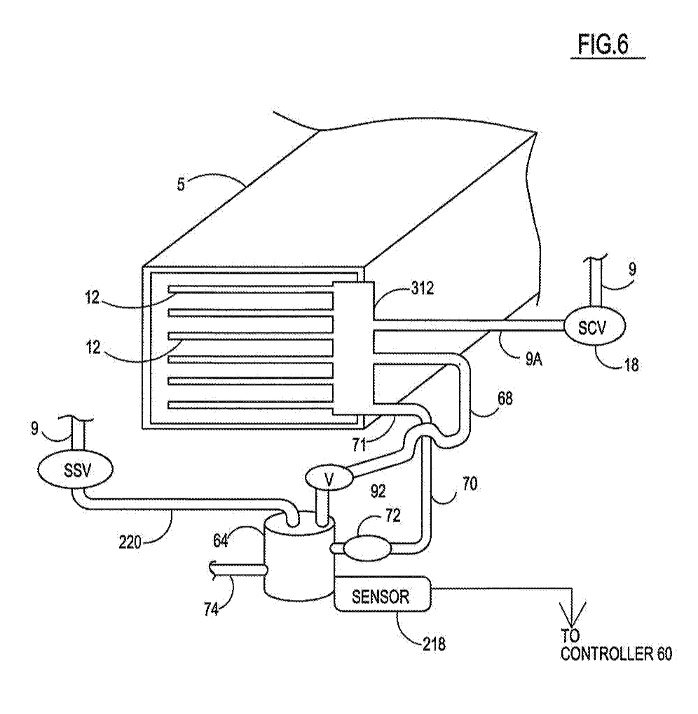

Rather than the illustrated vertical tubes 12, the dispersion tubes 12 may be disposed horizontally within the ductwork or ventilation closet (see FIG. 6). Each horizontal dispersion tube has a slight vertically downward sloped tube, wall or wall segment permitting condensate to drain into a generally vertical steam header. Other tubular configurations (rather than a sloped system) may be used with horizontal dispersion tubes.

Supply steam from boiler 50 (or other sources of supply steam) is fed to pressurized steam supply line 9. Pressure supply line leads to steam control valve 18 and to steam separator 26. Steam separator 26, line 215, temperature sensor 111, steam trap 113, and check valve 115 are all commonly used components to remove condensate which may accumulate in the supply line 9 and to adequately control the quality and quantity of supply steam upstream of the steam control valve 18 (SCV 18). Controlled release of humidification steam is achieved via controlled SCV valve 18 and supply line 9A.

The delivery of humidification steam is controlled by steam control valve 18 (SCV 18). SCV 18 is under the command of controller 60. Controlled humidification steam is applied to steam distribution header 6 via steam supply line 9A. A typical humidification system includes temperature sensors (not shown) upstream and downstream of the steam dispersion tubes 12. Output signals from these temperature sensors are applied to controller 60 (typically a micro-processor based controller preprogrammed with software algorithms, and operative with memory and display signal outputs) and the controller 60 generates appropriate humidification steam ON and steam OFF commands to the SCV valve 18.

The humidification operation of steam dispersion system 2, that is, the delivery of humidification steam into the duct or ventilation closet, is known in the industry. Controller 60 comprises a variety of devices including computers, micro processors, or the like. The controller receives signals from various elements, such as temperature signals from upstream and downstream temperature sensors (upstream and downstream referring, in some cases, to positions in the heat-ventilation HVAC ductwork, as referenced from the position of the steam distribution tubes). In one embodiment, the controller 60 can be wired to various steam distribution apparatuses 4 or it can communicate wirelessly with the steam distribution apparatus 4 to send and receive signals from that and other controlled devices.

In this manner, humidification steam is controllably supplied to steam header 6 and ultimately to steam dispersion tubes 12. Dispersion tubes 12 are disposed in ductwork 5, a steam or ventilation closet, or other appropriate segment in the heat-ventilation system in a building. Humidified air flows in the ductwork downstream of the dispersion tubes 12. Although ductwork 5 is illustrated herein, the condensate removal system works equally well in a steam or humidification closet.

The present invention removes condensate from the steam dispersion apparatus (generally, the dispersion tubes 12, header 6, piping, etc.). Due to the difference between the steam temperature dispersed from tubes 12 and the air temperature upstream in the ductwork (or ventilation closet), that is, the ambient air flowing through the ventilation system, some condensate 3 may form, first in the tubes and then in the interior of the steam header 6. In a vertical dispersion tube configuration (FIG. 1), condensate runs down the tubes into the steam distribution header 6. In general, the same is true for horizontal dispersion tube-generated condensate (see FIG. 6). The purpose of the present inventive system and method is to remove such condensate from dispersion apparatus 4 and, more particularly from header 6.

Header 6 has a lower region, wall or wall segment 7 which is sloped at angle “a” such that condensate reaching such lower header region flows into drain port 71. The location of drain port 71 may be at any convenient location wherein condensate in the lower header region flows into the drain. Slope a is measured from any horizontal plane through the header 6. Steam header 6 can comprise of a variety of materials.

The steam distribution header may have various lateral cross-sectional configurations (cross-sectional with respect to the longitudinal axis (the axis being left to right in FIG. 1)), especially with respect to the lower wall or lower wall segments. For example, V-shaped lower segments, U-shaped segments, V-shaped with a flat lower bottom, semi-circular shape and multi-angulated shapes may be operatively employed to enhance condensate flow in an effort to substantially eliminate condensate collection in header 6. Alternatively or in addition thereto, the lower wall or wall segments may be sloped over a longitudinal cross-section of the header. If drain 7 is at a longitudinal mid-point, a shallow V-shaped slope would move condensate to the midpoint drain. In this fashion, the lower wall or wall segments 7 of header 6 can be variously shaped to drain condensate to the drain and into drain pipe or tube 70.

The removal system and method drains condensate from drain port 71, through intermediate piping 70 and check valve 72 (or other one-way valve), to pressure condensate removal (PCR) tank or container 64. Condensate accumulates in collection tank or container 64.

An electronic level sensor 218 (ELS 218) senses the condition of condensate in containment tank 64. The ELS may measure of sense the difference between condensate, at the sensor level, and gas at that level. The ELS is any nonmechanical sensory device. For example, the ELS can sense temperature, resistance, capacitance, inductance, luminance or sonic condition of the condensate. For temperature, there is a small but detectable difference or differential between the gas at the sensory level and the condensate liquid at the sensory level. Condensate can also be detected by measuring liquid resistance, capacitance or inductance. Light may be able to detect condensate level by comparing a luminance condition in the collection PCR tank 64. An ultrasound level detector uses sound or sonic conditions to detect a condensate level.

The importance of the use of an ELS is that the absence of mechanical elements eliminates sensory errors due to clogging and mechanical wear on the mechanical elements. An ELS 218 does not suffer from these potential failures.

The present invention provides a condensate collection tank substantially without any mechanical obstructive elements within the tank, including mechanical moving parts, to substantially facilitate, reduce or eliminate the impedance of mineral and other deposits on the functioning of the condensate evacuation system. In the present system, there are no mechanical moving parts in the PCR tank 64 used to detect or determine the level of condensate. In mechanical systems which detect condensate level, minerals and other solids accumulate on mechanical moving parts in the collection tank over time. These mineral deposits and solids deposits interfere with the mechanical level detection structures, thereby degrading the level detection function of such mechanical level detection systems. The present invention avoids these problems by eliminating all mechanical level detection elements or structure in the condensate collection tank.

The condensate in a humidification system has a higher concentration of minerals and chemical compositions which concentrated condensate liquid, when in the collection tank, may transform into solid or semi-sold deposits on mechanical structures or elements in the collection tank. Therefore, the detection of condensate level without mechanical structures or elements improves the long-term operation of the condensate pumping system. Further, after isolating condensate in the collection tank from the dispersion tubes and header, the system detects a condensate level in the collection tank without any mechanical obstructive elements within the tank and then pumps condensate from the collection tank based upon the detected condensate level.

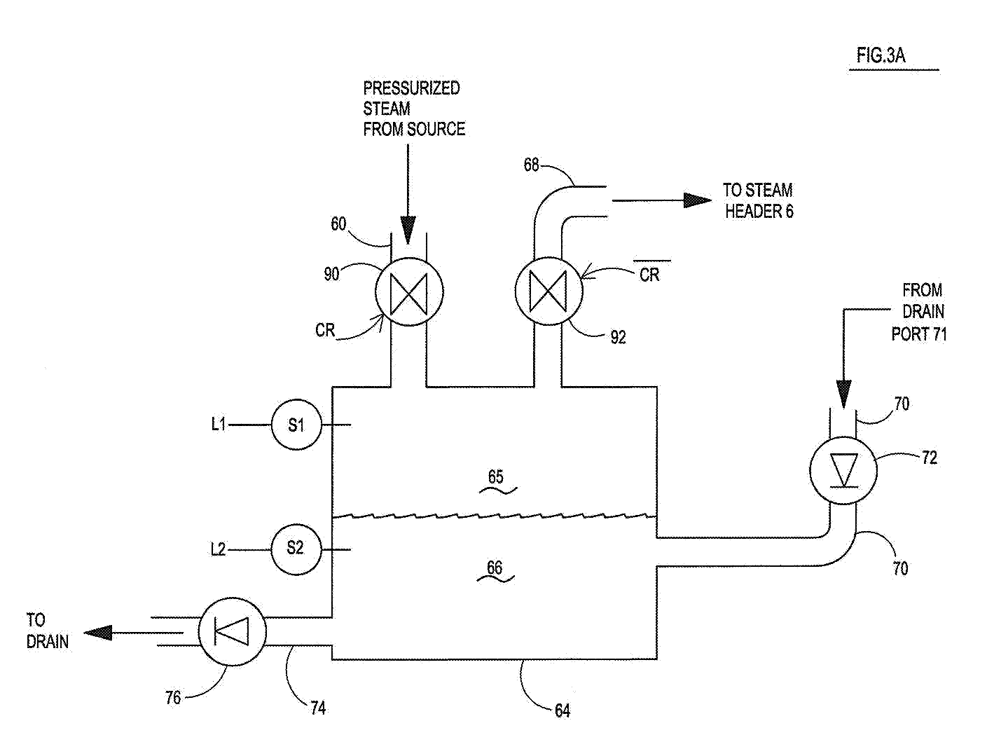

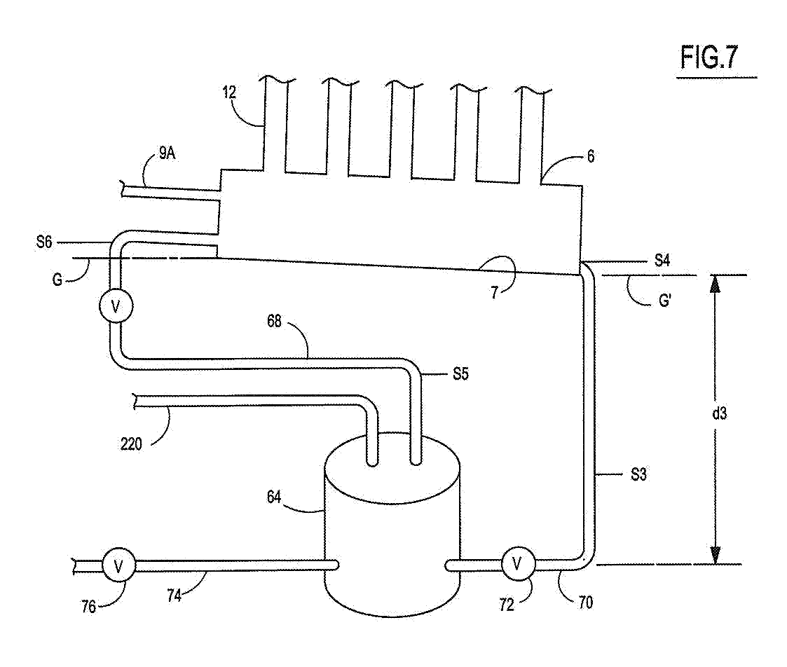

With respect to a temperature ELS, the temperature of the steam is higher than the temperature of the collected condensate, the ELS temperature sensor 218 detects this temperature differential and the interior condition or state of the PCR container 64. The location of the ELS sensor can be altered. See FIGS. 3A and 7.

Pressurized steam in supply line 9 is supplied to steam supply valve 90 (SSV 90) based upon a condition signal from the ELS 218. The ELS controlled steam supply valve pumps condensate from the PCR collection tank with the application of pressurized steam into the closed PCR tank 64. Although an “ELS controlled steam supply valve” is referred to herein, that ELS signal is conditioned by controller 60 and the resulting signal is applied as a control signal to the SSV 90. SSV 90 is ELS controlled which ELS control indicates either the presence or the absence of condensate in the collection tank. In FIG. 1, a SSV valve control signal C1 is applied to the control input of SSV valve 90. Steam under pressure is supplied via intermediate piping to the collection PCR tank 64 when SSV valve 90 is OPEN or ON.

The ELS-based control C1 is usually representative of (a) a condition of condensate in the PCR tank 64 and (b) a time-based function related to the humidification cycle (effectively when the humidification valve SCV 18 is delivering steam to the header 6. The control is level-sensor-based due to a differential between the supply steam fed via SSV 90 and the condensate in tank 64. The control signal C1 is time-based in order to pump out all or substantially all of the condensate from tank 64 due to the ON-OFF humidification cycle of humidification valve SCV 18. Other ELS-sensor-based and SCV time controls are discussed later.

At an appropriate time (ELS-based and time based), condensate in PCR tank 64 is pushed, via the controlled supply of pressurized steam, from tank 64 through check valve 76 and out of condensate return line 74 based upon a temperature control signal. This pump action is a pressure pulse. This condensate is delivered (propelled) to main condensate return line 77 until the tank is evacuated. Any condensate from steam trap 113 (downstream of check valve 115) is also delivered to main condensate return line 77 via line 75.

At an appropriate time and based upon an appropriate control function, the pressure in PCR tank 64 is reduced by opening relief valve 92 on intermediate line 68 running between PCR tank 64 and header 6. When SSV valve 90 is open, relief valve 92 is closed or OFF.

The problem solved by the present invention is the removal of condensate from the lower regions of steam header 6 since condensate collects on the lower wall or wall segment 7 which defines the bottom of the header region. This unwanted condensate is effectively removed from steam header 6 via the PCR removal system.

Sometimes the use of pressurized steam to move a liquid is provided by a pressure motive pump. Several pressure motive pumps, used in humidification systems, are discussed above in the background of the invention. These pressure motive pumps suffer from mechanical failure due to clogging and machine part wear over time. These machine parts are located in the condensate tank itself.

The pressure condensate removal PCR system operates by channeling condensate from the lower regions of the header 6 (see angular slope a of wall segment 7 in FIG. 1) into PCR collection tank 64. Controller 60 opens the steam supply valve SSV 90 (see command signal C1) at timed intervals to empty the collection tank 64. In a simple format, controller 60 has a timer module for generating the SSV valve control signal C1 to pump condensate from tank 64. Check valve 72 prohibits flow back up through line 70 to header 6 (one-way flow permitted to tank 64, back flow being prohibited by valve 72). To push collected condensate from tank 64, relief valve 92 is closed OFF (see command signal C2). Condensate from PCR tank 64 is pushed from the tank via check valve 76 (or any one-way valve) into condensate return line 74 and ultimately to main condensate return line 77. Valve control signals are generated by controller 60.

ELS sensor 218 senses a condition of condensate in the tank 64. The condensate condition or level can be sensed by temperature, resistance, capacitance, inductance, luminance or sonic condition. The condition is a differential between condensate and the presence of the pressurized steam in the interior of PCR collection tank 64. This ELS signal LS is supplied to controller 60. The controller is pre-programmed to detect (i) when condensate is at a predetermined sensory level and (ii) when pressurized steam is at the sensory level. A variety of ELS sensors may be used.

If a temperature ELS sensor is used, the temperature sensor normally senses the temperature of the condensate which is generally slightly below the boiling point (about 180-200 degrees F.). The temperature of pressurized steam is generally above the boiling point. When the timed evacuation cycle starts, the valve 90 pressurizes tank 64 (relief valve 92 being closed). The temperature sensed by ELS sensor 218 monitors condensate temperature and steam temperature. When PCR tank 64 is empty, the temperature in tank 64 corresponds to the steam temperature which is above the boiling point (about 200 degrees F.). Controller 60 detects this change in the ELS signal LS, closes the PCR supply SSV valve 90 and opens pressure relief valve 92. When relief valve 92 is OPEN, pressurized steam from tank 64 then enters header 6 until the pressure in the PCR tank 64 matches the pressure in the header. Condensate, forming on the tubes 12 and falling into header 6, flows out of the lower regions of the header, through drain port 71, line 70 and through one-way valve 72 into PCR tank 64. Back flow from condensate return pipe 74 is blocked by check valve 76.

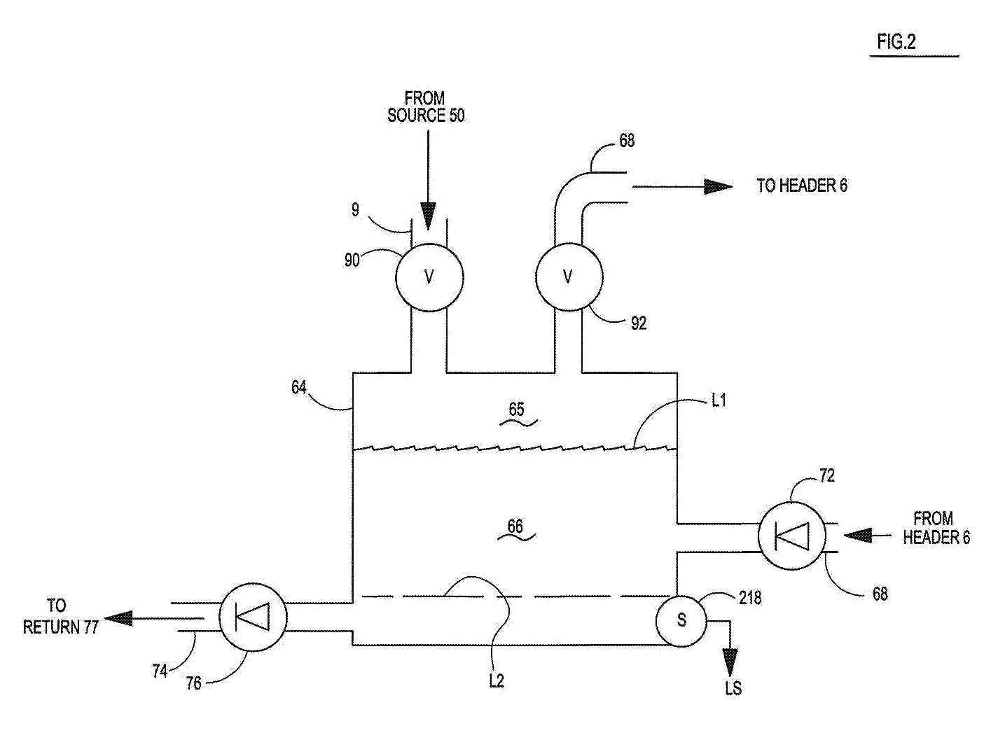

FIG. 2 diagrammatically illustrates operational aspects of the PCR system and method. Condensate accumulates or is collected in tank 64. In FIG. 2, condensate reaches level L1. Lower tank region 66 holds condensate while upper region 65 is at the header pressure (the pressure inside the header) due to open relief valve 92 and relief line 68. At timed intervals, controller 60 commands valve 90 to open, forcing condensate out of the tank via one-way valve 76 and return line 74. Relief valve 92 is closed during the pump-out period when supply valve 90 is open.

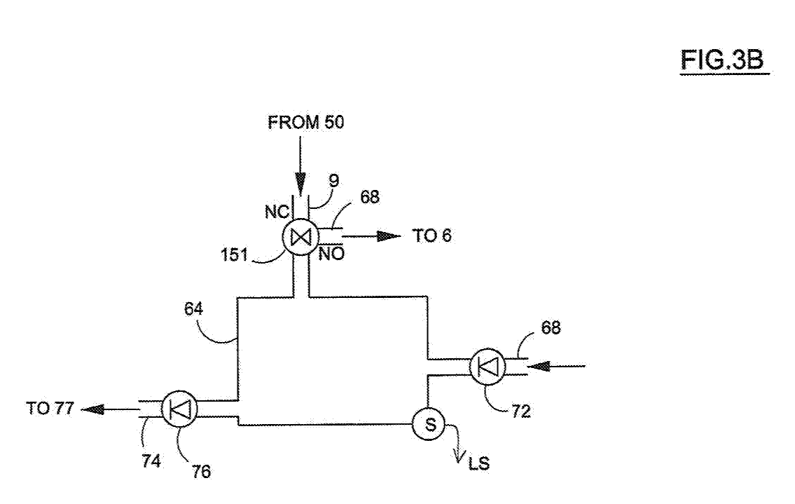

FIG. 4A is a timing diagram indicating that, at time t1, the humidification steam valve SCV 18 goes ON (opens) after a certain time. At a predetermined time thereafter (see time differential t1 to t2, a time function f(SCV)), the relief valve 92 is closed (OFF) and the steam supply valve SSV 90 is open (ON) and condensate is pumped out of PCR tank 64. At time t3, the ELS sensor 218 detects pressurized steam and at t4 the SSV valve 90 is closed and relief valve 92 is open (this being an ELS-based function f(L)). Various pre-programmed functions f(SCV) and f(L) (computer programs or control algorithms) may be activated by controller 60.

For example, in an initial operational phase, designers can estimate when PCR tank 64 should be pumped out given certain quantities and qualities of humidification steam dispersed by tubes 12. This control algorithm is a time-based control based upon SCV 18 going OPEN (t1 in FIG. 4A). The “time to completely empty” tank 218 can be determined by monitoring ELS-based signals LS (t2 to t3 in FIG. 4A). This time to empty is a “pressure pulse” applied over a period t-2 to t-3. Multiple cycles of “apply humidification steam” and “empty PCR tank” can teach the controller 60 when to empty tank 64 based up adaptive control signal theory. For example, after a predetermined number “n” of humidification cycles and over several day-night cycles, the controller 60 can predict an appropriate evacuation pump-out time for the PCR after “m” number of humidification ON cycles. In this situation, the ELS acts as a safety feature and the evacuation pump-out PCR cycle is a timed function based upon SVC action.

Also the “post-temperature period” t3 to t4 can be shortened with such adaptive control signal theory. Adaptive controls find (i) the width of the pressure pulse which best empties the tank and (ii) the best times to apply the pressure pulse given the SCV humidification operation.

In FIG. 2, when condensate reaches sensory level L2 (a lower sensor level), ELS signal LS from ELS sensor 218 changes and the controller 60 closes SSV supply valve 90 and opens relief valve 92. The controls are configured to pump out all of the condensate from tank 64. Either the shape of the lower region of the tank can be engineered for this effect, or the sensor 218 can be strategically located or controller 60 can be programmed to supply pressurized stream for a set or predetermined period of time after the pressurized steam temperature is sensed (that pressurized steam temperature being slightly above the boiling point). The steam supply from SSV 90 continues for time t4 after ELS-differential-sensed time t3 in FIG. 4A.

During the condensate collection phase, check valve 76 is closed due to the column of water in intermediate return line 74. During the pumping or condensate evacuation phase, check valve 72 is closed due to pressurized steam supplied into PCR tank 64 and the closure of relief valve 92.

Immediately after PCR supply valve SSV 90 is closed, there is residual pressure in the tank 64. After supply valve SSV 90 closes (when the condensate is effectively substantially pumped out of PCR tank 64), check valve 76 is closed due to the column of condensate in line 74 and check valve 72 is closed due to the residual pressure left in the PCR tank 64. At that moment, the pressure in tank 64 will equal the pressure of the closure spring in check valve 76 plus the pressure of the condensate column in line 74 (see vertical distance d1). This residual pressure will keep check valve 72 closed, not permitting the free flow of condensate from the lower region of the header 6 into PCR tank 64. This residual pressure is released when relief valve 92 opens. When relief valve 92 opens (and SSV 90 is closed), condensate is thereafter collected in PCR tank 64 via check valve 72. The condensate column in line 70 (see vertical distance d2) also promotes one-way flow through valve 72 and assures that an adequate evacuation steam pressure is present in PCR tank 64 to pump out the condensate to return line 74.

The present system and method has several advantages. There is no heat exchanger in the system which is sensitive to mineral deposit accumulation which reduces efficiency and can cause flooding in the main system. All PCR components are external to the header 6. The PCR system makes use of the industry standard condensate removal piping sub-systems (namely, removal of condensate via main condensate return line 77). The PCT tank 64, in a preferred embodiment, is stainless steel. The tank is separate from the steam header 6, is externally accessible, is removable and is replaceable. Condensate in the header is pumped away from the steam distribution system rather than accumulated in the header. Condensate is reused (via main return line 77) and managed outside the duct or ventilation closet. There is no heat transfer effected or required. There are no limitations of the steam dispersion tubes due to duct size. For example, an internal heat exchanger in the header 6 requires a larger header which limits dispersion tube configurations. The PCR system only requires steam pressure to lift the condensate (approximately two (2) feet of lift per PSI of differential between steam supply and main condensate return). The PCR system can be used with insulated or non-insulated steam distribution tubes and headers.

The PCR system and method can use a variety of valves and ELS sensors.

FIG. 3A shows the use of two ELS sensors, S1 and S2. Upper sensor S1 indicates when the condensate liquid reaches level L1. Lower sensor S2 senses the lower condensate level L2. Controller 60 uses ELS signals LS1 and LS2 to turn OFF and ON the PCR supply SSV valve 90. As for control signals from controller 60, the “open supply valve” signal to the PCR SSV is CR (condensate removal). A NOT CR signal is applied to relief valve 92 (such that when SSV is open and providing steam to tank 64, relief valve 92 is closed). When the supply valve SSV is open with CR, the relief valve is closed with NOT CR.

FIG. 3B shows a combinatory valve 151. Supply line 9 side is “normally closed” NC and pressure relief line 68 side is “normally open” NO. Control valve 151 has a normally closed NC valve position blocking supply steam on line 9 from entering into container space 65 (FIG. 2) and a normally open NO condition on relief line 68 whereby pressure in upper container region 65 is released back or vented into steam header 6.

Alternatively, the venting of pressure from upper region 65 of tank 64 could be accomplished by a vent to the ambient environment. This vent-to-atmosphere may not be an energy efficient configuration.

In operation, control valve 151 is normally closed NC which blocks supply line pressure in line 9 and the relief valve side is normally open NO to vent pressure to relief line 68. This vents off any pressure which may build up in the container 64 due to the accumulation of condensate in vessel container 64.

In FIG. 3A, ELS sensors S1, S2 supply signals to the controller 60 which determines when the level of condensate in region 66 rises above or falls below predetermined levels. When condensate rises above the upper ELS sensor S1, the condition of the condensate is different than the ambient gaseous condition in upper region 65 and controller 60 is programmed to detect this change (the change between the ambient gas in upper region 65 compared with the condition of condensate in lower region 66). This change in condensate condition is represented by set points preprogrammed in controller 60. When the specified condition is sensed by S1 and controller 60, a control signal CR is generated by controller 60 and this CR control signal is applied to control valve 90. The specified condition may be temperature, resistance, capacitance, inductance, luminance or sonic condition of the condensate or gas in tank 64.

FIG. 4B diagrammatically illustrates a timing chart for the pressure condensate return system wherein the activation of the pressure pulse to pump out condensate from the container is a function of ELS-sensed condition (see f(L)). For example if a high positioned ELS sensor S1 at level L1 is used (see FIG. 3A), per the control method shown in FIG. 4B, at time t1, as a function of ELS condition f(L), the pump-out sequence begins with the opening supply valve SSV 90. This continues until time t2 (a simple time-out function). An adaptive control program in controller 60 may use lower ELS sensor S2 (FIG. 3A) to determine “near tank evacuation” and shift (enlarge or contract) the pump-out time interval t1 to t2 based upon actual operating conditions in the humidification system.

Alternatively, upper ELS sensor S1 could be a safety system to avoid an over-filled condition of tank 64.

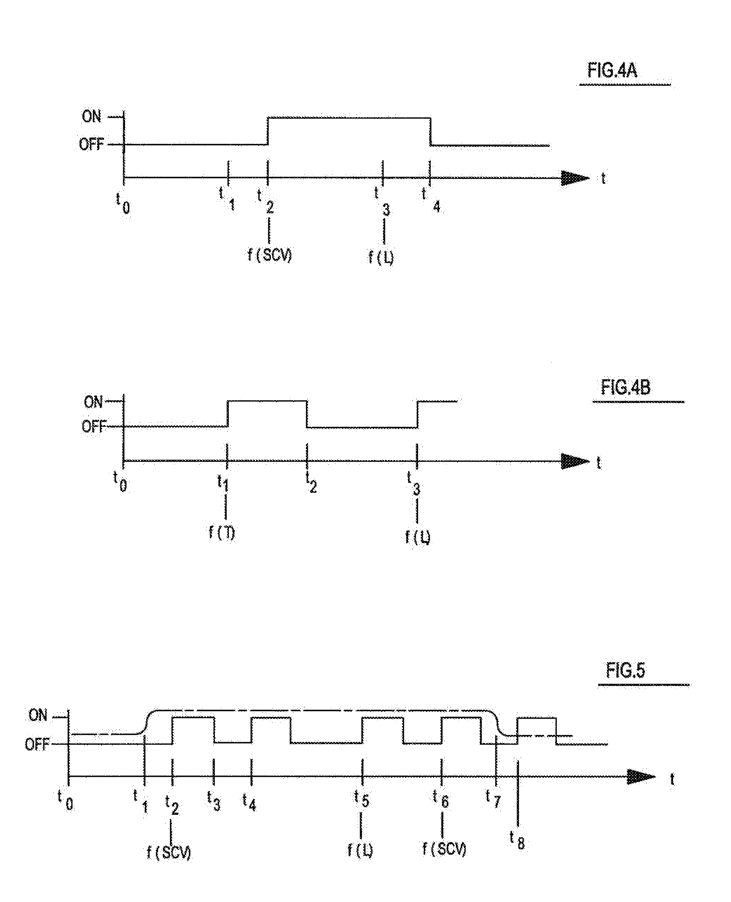

FIG. 5 diagrammatically illustrates a different timing control for the PCR tank wherein combinatory control signals are applied to the pressure pump valve SSV 90. The SSV supply valve can supply one or more pressure pulses to pump out condensate from the container, which is a function of SCV, the “length of time for humidification steam supplied to header 6.” Humidification steam supplied via SCV 18 to the steam distribution header establishes control points for the pump-out or evacuation cycle of the PCR tank, as a function of the humidification steam control valve SCV, that is, f(SCV).

The humidification cycle works independently with respect to the evacuation cycle, that is, the evacuation cycle does not interfere with the humidity control.

At time t1, the SCV opens. At a timed differential t1 to t2, the tank evacuation process begins. This is a function of the humidification cycle set by SCV, or f(SCV). The evacuation pulse is t2 to t3 (represented by an open condition of SSV 90). At time t4, a second evacuation cycle is activated by controller 60. This cycle is also a function of f(SCV) or the humidification cycle. At time t5, an ELS-based condition is sensed by a properly located temperature sensor (the differential between steam and condensate) and another evacuation cycle is initiated by the controller 60. This is an ELS-based function f(L). At t6, since the SCV 18 is still providing humidification steam to dispersion tubes 12 (the SCV being ON from t1 to t7), another evacuation cycle is started by the controller at time t6. This is a function of the SCV condition, therefore f(SCV). At time t7, the SCV is closed (OFF) and at time t8 the tank 64 is evacuated again. This post-humidification action is another f(SCV).

Based upon the foregoing, various ELS sensors, placed at various locations in the condensate drain and pump system may be used to control evacuation of tank 64. ELS-based functions, time-based functions and humidification-based functions may be employed to remove condensate from header 6.

FIG. 6 shows horizontal humidification steam tubes 12. A vertical header 312 channels condensate to drain 71. The remainder of the PCR system is the same as described above. Various horizontal dispersion tube designs can be used with the PCR system described above. Typically, horizontal dispersion tubes are set at a down-angle of about 3 degrees to gravity-drain condensate into the header.

FIG. 7 diagrammatically illustrates multiple locations for the placement of ELS sensors (S3, S4, S5, S6) for the pressure condensate return PCR system. Although various diverse physical ELS sensor locations are shown in FIG. 7, the current embodiment uses a temperature sensor at S2 (lower tank location, FIG. 3A) or at S1 (a higher tank location). The particular sensor location is integrated with the control programs discussed above.

FIG. 7 shows alternate locations of the ELS sensor at: location S3 vertically above the input to tank 64; location S4 at the drain port on the header 6; S5 at a distance above the top of the PCR tank 64 on the pressure relief line 68; and at location S6 near the output of the pressure relief line 68 near the header 6. By having ELS sensors at these vertically higher locations, the PCR system can pump out more condensate, especially with evacuation cycles which are after or post SCV 18 “close” or OFF events (see FIG. 5, SCV OFF at t7 and the later evacuation cycle at time t8). However, with vertically higher ELS sensors (higher than the upper limit of PCR tank 64), other problems may arise with the pressure condensate pump system. Notwithstanding such water column concerns (see vertical distance d3), additional sensors may be reasonable if the production of condensate in header 6 is excessive in a certain humidification system. Multiple sensors are used to provide additional pressure evacuation pump-out cycles by controller 60.

FIG. 7 also shows that lower wall region 7 of header 6 may be on or near a horizontal plane noted by line G-G′.

The claims appended hereto are meant to cover modifications and changes within the scope and spirit of the present invention. What is claimed is:

1. A steam dispersion apparatus supplied with steam from a steam source comprising:
a plurality of steam dispersion tubes coupled to a header in communication with said steam source;
a condensate collection tank in communication with said header configured to collect condensate therefrom;
an electronic sensor sensing the level of condensate in said collection tank; and
a controlled steam supply valve pumping condensate from said collection tank based upon the level of condensate detected by said sensor.

2. A steam dispersion apparatus as claimed in claim 1 wherein said electronic sensor is a non-mechanical electronic level sensor sensing the condensate level.

3. A steam dispersion apparatus as claimed in claim 1 wherein said electronic sensor senses one of a gas-liquid differential of temperature, resistance, capacitance, inductance, luminance or sonic condition of condensate in the collection tank.

4. A steam dispersion apparatus as claimed in claim 1 wherein said electronic sensor employs one of a temperature, resistance, capacitance, inductance, luminance or sonic condition of the condensate in the collection tank.

5. A steam dispersion apparatus as claimed in claim 4 wherein the steam dispersion apparatus is part of a steam dispersion system, the steam dispersion apparatus including:
a drain in communication with said header and said collection tank; and
a controller for the steam supply valve indicates either the presence or the absence of condensate in the collection tank, header or drain based upon said electronic sensor.

6. A steam dispersion apparatus as claimed in claim 5 wherein said drain is a first drain line, the steam dispersion system includes at least one condensate return line, the steam dispersion apparatus including:
a second drain line in communication with said collection tank and said condensate return line for evacuation of said condensate from said collection tank.

7. A steam dispersion apparatus as claimed in claim 5 wherein said steam supply valve is in communication with said steam source which is used to pump condensate from the collection tank.

8. A steam dispersion apparatus as claimed in claim 1 including a timer control for said controlled steam valve for pumping said condensate.

9. A steam dispersion apparatus as claimed in claim 8 wherein said steam supply valve is in communication with said steam source which is used to pump condensate from the collection tank, the steam dispersion apparatus including:
a controller coupled to said electronic sensor for controlling the steam supply valve and the ON-OFF application of motive pumping steam to the collection tank;
a controlled pressure relief line in communication with the collection tank to release steam after the steam supply valve turns OFF pumping steam to the collection tank, said controller coupled to said controlled pressure relief line.

10. A steam dispersion apparatus as claimed in claim 9 including a first valve prohibiting flow from said tank to said header.

11. A steam dispersion apparatus supplied with steam from a steam source comprising:
a plurality of steam dispersion tubes coupled to a header in communication with said steam source;
a condensate collection tank in communication with said header configured to collect condensate therefrom;
a non-mechanical electronic sensor sensing the level of condensate in said collection tank, the electronic level sensor coupled to a controller; and
a steam supply valve controlled by said controller and pumping condensate from said collection tank based upon the level of condensate detected by said sensor.

12. A steam dispersion apparatus as claimed in claim 11 wherein said electronic level sensor is one of a temperature sensor, a resistance sensor, a capacitance sensor, and inductance sensor, a luminance sensor or a sonic sensor, and wherein the electronic level sensor senses the condition of condensate in the collection tank.

13. A method of removing condensate from a steam dispersion apparatus supplied with steam from a steam source comprising:
draining condensate from steam dispersion tubes and an associated header into a condensate collection tank;
isolating condensate in the collection tank from said dispersion tubes and header;
pumping condensate from the isolated collection tank based upon a non-mechanically sensed condensate level in said collection tank or said header.

14. A method of removing condensate as claimed in claim 13 including non-mechanically sensing condensate level via temperature, resistance, capacitance, inductance, luminance or sonic condition of said condensate.

15. A method of removing condensate as claimed in claim 14 including pumping condensate from the collection tank to a system condensate return line with steam from said steam source.

16. A method of removing condensate as claimed in claim 14 including pumping condensate with steam supplied by said steam source based upon a gas-liquid differential.

17. A method of removing condensate as claimed in claim 14 wherein pumping condensate is based upon either the non-mechanically sensed condensate level or a timing of the release of humidification steam from said dispersion tubes.

18. A method of removing condensate from a steam dispersion apparatus supplied with steam from a steam source comprising:
draining condensate from steam dispersion tubes and an associated header into a condensate collection tank;
isolating condensate in the collection tank from said dispersion tubes and header;
pumping condensate from the isolated collection tank based upon a sensed condition of condensate level which is temperature, resistance, capacitance, inductance, luminance or sonic condition of said condensate.

19. A method of removing condensate as claimed in claim 18 including pumping condensate from the collection tank to a system condensate return line with steam from said steam source.

20. A method of removing condensate as claimed in claim 19 including pumping condensate with steam supplied by said steam source based upon a gas-liquid differential.

21. A method of removing condensate as claimed in claim 19 wherein pumping condensate is based upon either the non-mechanically sensed condensate level or a timing of the release of humidification steam from said dispersion tubes.

22. A method of removing condensate from a steam dispersion apparatus supplied with steam from a steam source comprising:
draining condensate from steam dispersion tubes and an associated header into a condensate collection tank;
isolating condensate in the collection tank from said dispersion tubes and header;
pumping condensate from the isolated collection tank by detecting a condensate level without a mechanical structure;
thereby eliminating any mechanical impedance caused by mineral or other deposits from the condensate.

23. A method of removing condensate as claimed in claim 22 including pumping condensate from the collection tank to a system condensate return line with steam from said steam source.

24. A method of removing condensate as claimed in claim 22 wherein pumping condensate is based upon either detecting a condensate level without a mechanical structure or a timing of the release of humidification steam from said dispersion tubes.

25. A method of removing condensate from a steam dispersion apparatus supplied with steam from a steam source comprising:
draining condensate from steam dispersion tabes and an associated header into a condensate collection tank;
isolating condensate in the collection tank from said dispersion tubes and header;
detecting a condensate level in the collection tank without any mechanical obstructive elements within the tank;
pumping condensate from the collection tank based upon the detected condensate level; and
thereby eliminating any mechanical impedance caused by mineral or other deposits from the condensate.

26. A method of removing condensate as claimed in claim 25 including pumping condensate from the collection tank to a system condensate return line with steam from said steam source.

27. A method of removing condensate as claimed in claim 25 wherein pumping condensate is based upon either detecting a condensate level without mechanical obstructive elements or a timing of the release of humidification steam from said dispersion tubes.

28. A steam dispersion apparatus as claimed in claim 1 wherein the controlled steam supply valve pumps condensate either fully or partially from said collection tank.

29. A method of removing condensate from a steam dispersion apparatus as claimed in claim 22 including fully or partially pumping condensate from the isolated collection tank.

30. A steam dispersion apparatus supplied with steam from a steam source comprising:
a plurality of steam dispersion tubes coupled to a header in communication with said steam source for the release of steam through the steam dispersion tubes, said header adapted to collect condensate from the steam dispersion tubes;
a condensate collection tank, in fluid communication with and downstream of said header, for the collection of condensate from the header; and
a controlled steam supply valve pumping condensate from said collection tank based upon a time-based control from a controller and the release of steam from the steam dispersion tubes.

31. A steam dispersion apparatus as claimed in claim 30 wherein the controlled steam supply valve pumps condensate either fully or partially from said collection tank.

32. A steam dispersion apparatus as claimed in claim 30 wherein the steam dispersion apparatus is part of a steam dispersion system and the steam dispersion system includes at least one condensate return line, wherein the controlled steam supply valve is in communication with said steam source for the controlled release of steam into said collection tank, and the steam dispersion apparatus further including:
a first drain line in fluid communication with and between said header and said collection tank;
a second drain line in communication with said collection tank and said condensate return line for evacuation of said condensate from said collection tank; and
at least one valve to isolate said condensate collection tank from said header during the pumping of condensate from the collection tank.
